(19) United States
(12) Patent Application Publication
(10) Pub. No.: US 2022/0279770 A1
(43) Pub. Date: Sep. 8, 2022

(54) APPARATUSES FOR FISHING ROD HOLDERS

(71) Applicant: 360 Marine Inc., Farmington, MI (US)

(72) Inventors: Mark Chmura, Bear Lake, MI (US); Jason Paskaramoorthy, Farmington Hills, MI (US)

(73) Assignee: 360 Marine Inc., Farmington, MI (US)

(21) Appl. No.: 17/191,057

(22) Filed: Mar. 3, 2021

(51) Int. Cl. A01K 97/10

(52) U.S. Cl. CPC A01K 97/10

(57) ABSTRACT

An apparatus for securing equipment to a rod holder includes a housing extending along a center axis and having a chamber therein. The housing is configured to be inserted into the rod holder. A leg is configured to radially extend from the housing to thereby engage the rod holder and prevent movement of the apparatus relative to the rod holder. A cap is on the housing and is configured to permit the equipment to be coupled to the apparatus.

### FIELD

The present disclosure relates to apparatuses for fishing rod holders, and specifically to apparatuses for insertion into fishing rod holders to thereby support fishing equipment therefrom.

### BACKGROUND

Marine vessels, such as fishing boats, includes fishing rod holders that are recessed into the hull of the vessel. The rod holder is commonly a hollow cylinder with a first end having a flange coupled to the hull and a second end having a gimble bar or pin extending through the bore of the cylinder. Fishing rods can be placed into the bore of the cylinder such that the rods are held in an upright position. Other fishing equipment, such as heavy tackle or downriggers, can also be used during fishing operations. The fishing equipment often has dedicated mounts secured the hull.

The following U.S. Patent is incorporated herein by reference in entirety.

U.S. Pat. No. 9,326,496 discloses an adjustable holding assembly for supporting a tubular member and includes a base assembly adapted to be mounted to a support surface. The base assembly includes a vertical shaft defining a vertical pivot axis, and a horizontal shaft rotatable about the vertical shaft and defining a horizontal pivot axis. A holder is adapted to receive the tubular member and is pivotally mounted to the base assembly so that the holder is simultaneously rotatable about the vertical pivot axis and the horizontal pivot axis. A single latching arrangement is carried by the horizontal shaft and is configured for selective engagement and disengagement with the base assembly to permit a one-handed adjustment of the holder simultaneously about the vertical pivot axis and the horizontal pivot axis or separately about either the vertical pivot axis or the horizontal pivot axis to multiple angular locked positions with respect to the base assembly.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, an apparatus for securing equipment to a rod holder includes a housing extending along a center axis and having a chamber therein. The housing is configured to be inserted into the rod holder. A leg is configured to radially extend from the housing to thereby engage the rod holder and prevent movement of the apparatus relative to the rod holder. A cap is on the housing and is configured to permit the equipment to be coupled to the apparatus.

In certain examples, an apparatus for securing equipment to a rod holder includes a housing extending along a center axis and having a chamber therein. The housing is configured to be inserted into the rod holder. A first yoke is located in the chamber and axially fixed relative to the housing, and a second yoke is located in the chamber and spaced apart from the first yoke. A leg is coupled to and extends between the first yoke and the second yoke. A cap is located on the housing and is configured to permit the equipment to be coupled to the apparatus. A handle is operably coupled to the second yoke such that operation of the handle causes the second yoke to axially move toward the first yoke and the leg to radially extend from the housing. As such, the leg is configured to engage the rod holder and prevent movement of the apparatus relative to the rod holder.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a perspective view of an example apparatus of the present disclosure in a rod holder.

FIG. 2 is a perspective view of the apparatus of FIG. 1 removed from and aligned with the rod holder.

FIG. 3 is an exploded, cross-sectional view of the apparatus of FIG. 1.

FIG. 4 is a cross-sectional view of the apparatus of FIG. 1

FIG. 5 is a side view of the apparatus of FIG. 1 in the rod holder with the legs in retracted positions.

FIG. 6 is a side view of the apparatus of FIG. 1 in the rod holder with the legs in extended positions.

FIG. 7 is a cross-sectional view of the apparatus of FIG. 1 in the rod holder with the legs in the extended positions.

FIG. 8 is a partial perspective view of the apparatus of FIG. 1 with the legs in the retracted positions.

FIG. 9 is a partial perspective view of the apparatus of FIG. 1 with the legs in the extended positions.

FIG. 10 is a partial cross-sectional view of the apparatus of FIG. 1 with the legs in the extended positions.

### DETAILED DESCRIPTION

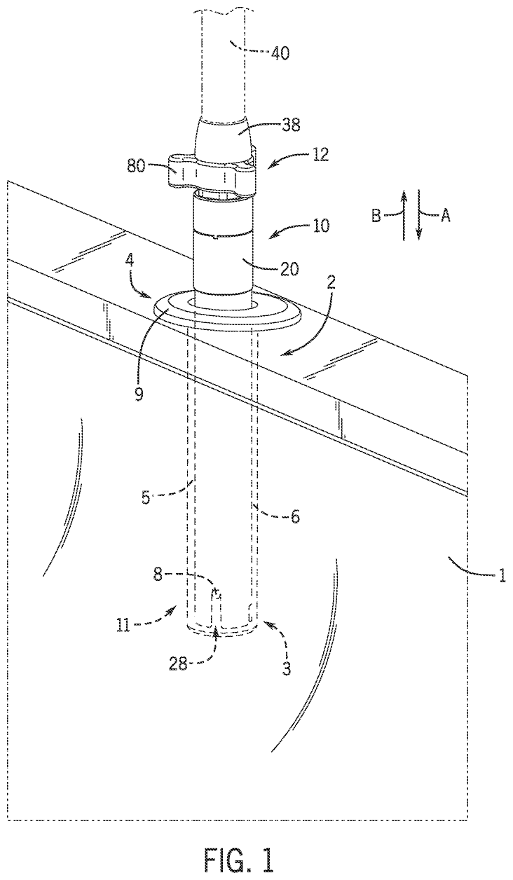

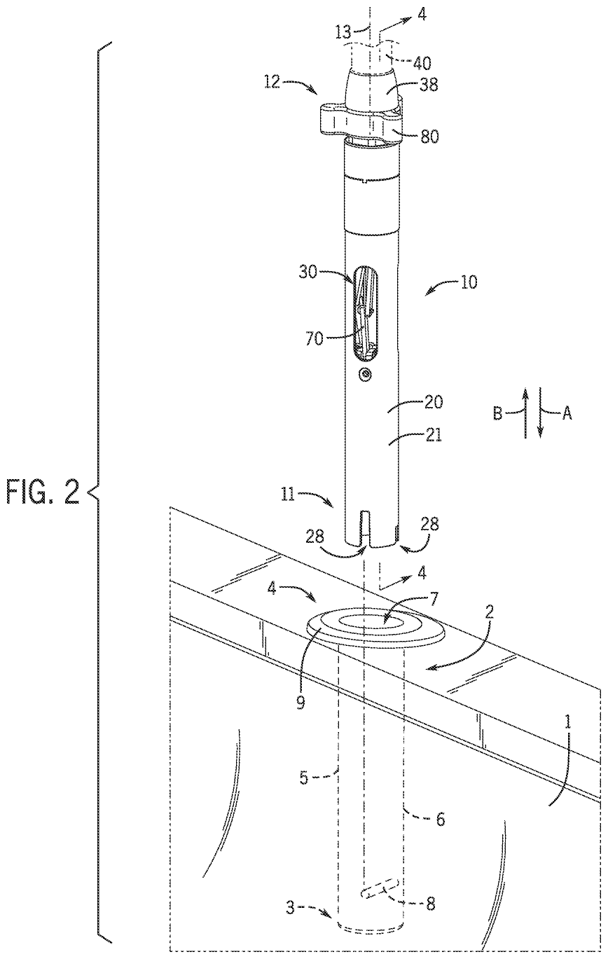

FIGS. 1-2 generally depict an example apparatus 10 of the present disclosure. Specifically, FIG. 1 depicts the apparatus 10 received in a hollow cylinder 5 of a rod holder 2. The rod holder 2 is recessed into the hull 1 of a boat. FIG. 2 depicts the apparatus 10 removed from the rod holder 2.

The rod holder 2 is commonly used to hold fishing rods such that the user can set multiple fishing lines and/or attend to other fishing tasks. The rod holder 2 has a first end 3 at the gunwale of the boat and a second end 4 recessed in the hull 1. The cylinder 5 extends between the first end 3 and the second end 4, and the cylinder 5 has a rod holder sidewall 6 that defines a bore 7 in which a fishing rod (not depicted) or the apparatus 10 of the present disclosure can be received. A flange 9 at the first end 3 secures the rod holder 2 to the gunwale. A gimble pin or bar 8 is at the second end 4 (described hereinbelow). The size and/or shape of the components and features of the rod holder 2, can vary from manufacturer to manufacturer. For example, the diameter of the bore 7 in a first example rod holder 2 may be 1.50 inches and the diameter of the bore 7 of a second rod holder 2 may be 1.25 inches.

In addition to rod holders, a boat may include one or more mounts fixedly coupled to the gunwale or hull 1 so that other fishing equipment, such as heavy tackle or downriggers, can also be mounted thereto. These mounts often require that a user drill into or otherwise fixedly attach the mounts to the boat. As such, the boat may have numerous mounts for various types of equipment. Removal of the mounts, either intentionally or unintentionally, may cause damage to the boat.

The present inventors have recognized that there is need in the industry for apparatuses that permit fishing equipment, other than fishing rods, to be secured to the hull via existing rod holders so as to avoid coupling various mounts to the hull. The present inventors have further recognized that such apparatuses should be insertable into different rod holders thereby increasing the usefulness and compatibility of the apparatus and decreasing the need to manufacture different apparatuses for use with differently sized and shaped rod holders. Thus, through research and experimentation, the present inventors developed the apparatuses described herein to address the problems and issues noted above. Furthermore, the present inventors developed the apparatuses described herein that can be quickly and easily inserted and removed from a rod holder and which requires no modification to the rod holder.

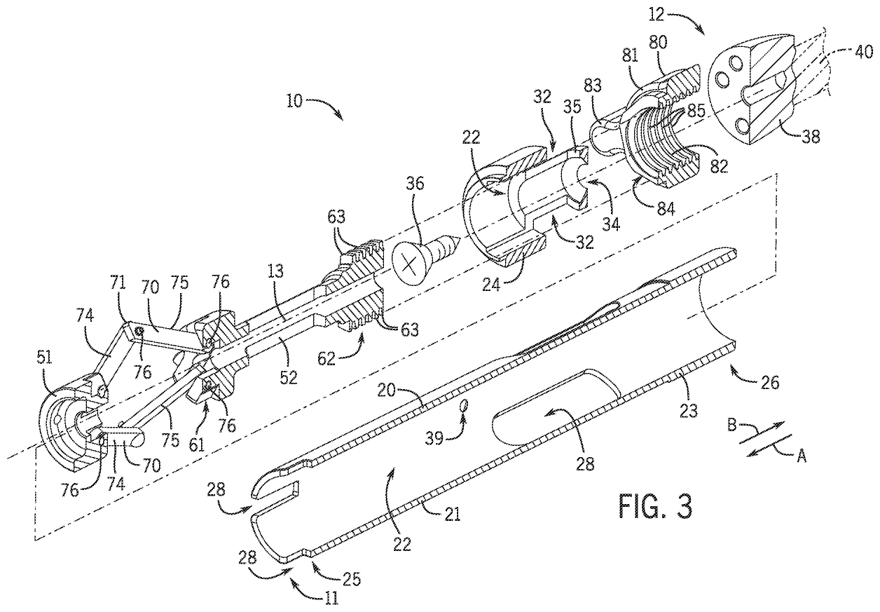

Turning now to FIG. 3, the example apparatus 10 of FIGS. 1-2 is depicted in greater detail. The apparatus 10 has a first end 11 and an opposite second end 12 (see also FIG. 2). The apparatus 10 extends along an axis 13 between the ends 11, 12, and the apparatus 10 has a housing 20 that extends along the axis 13. The housing 20 has a housing sidewall 21 that defines a chamber 22 in which other components of the apparatus 10 are positioned (described herein), a first housing end 25, and an opposite second housing end 26. The housing 20 is generally cylindrically shaped. The housing 20 is formed from one or more hollow members, and in the example depicted in FIG. 3, the housing 20 is formed with a pair of tubes, namely a first tube 23 and a second tube 24, that are coupled to each other. Note that the chamber 22 extends through the tubes 23, 24. In certain examples, the housing 20 may be formed with a single, unitary tube.

One or more slots 28 are defined in the housing sidewall 21 near the first housing end 25. The slots 28 are configured to be received around the gimble bar 8 (FIG. 2) and thereby prevent rotation of the apparatus 10 about the axis 13 while the apparatus 10 is in the rod holder 2 (FIG. 2). Thus, the slots 28 act as a rotational lock when the gimble bar 8 is received therein. In operation, the user inserts the apparatus 10 in the rod holder 2 such that first housing end 25 contacts the gimble bar 8 and preferably the gimble bar 8 is in one or more slots 28. Note that the slot 28 must be aligned with the gimble bar 8 (see FIG. 2) in order for the gimble bar 8 to be received therein. In the event the slot 28 is not aligned with the gimble bar 8, the user rotates the apparatus 10 about the axis 13 until the slot 28 is aligned with the gimble bar 8. Note that the apparatus 10 can be utilized with rod holders 2 devoid of gimble bars 8.

One or more openings 30 are also defined in the housing sidewall 21, and the openings 30 are positioned between the housing ends 25, 26. The openings 30 permit components within the chamber 22 to extend therethrough. The number, size, and/ shape of the openings 30 can vary, and in one example, three openings 30 are spaced apart in the housing sidewall 21 and around the chamber 22 and the axis 13.

In addition, one or more cutouts 32 are defined in the housing sidewall 21, and the cutouts 32 are positioned near the second housing end 26. The cutouts 32 permit screw threads of a yoke 52 (described hereinbelow) to extend therethrough. The number, size, and/ shape of the cutouts 32 can vary, and in one example, two cutouts 32 are spaced apart in the housing sidewall 21 and around the chamber 22 and the axis 13.

Furthermore, a hole 34 is defined in an end wall 35 at the second housing end 26. The hole 34 is capable of receiving a fastener, such as a screw 36, that couples a cap 38 to the housing 20. As such, fishing equipment 40, such as a downrigger, can be coupled to the housing 20 via the cap 38. Note that in another example, the hole 34, the screw 36, and/or the cap 38 are excluded such that the fishing equipment 40 is directly coupled to the end wall 35. In another example, the cap 38 is part of the fishing equipment 40.

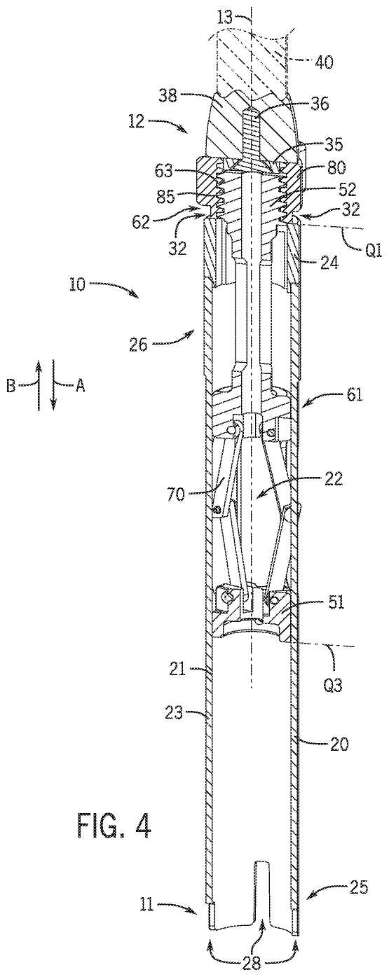

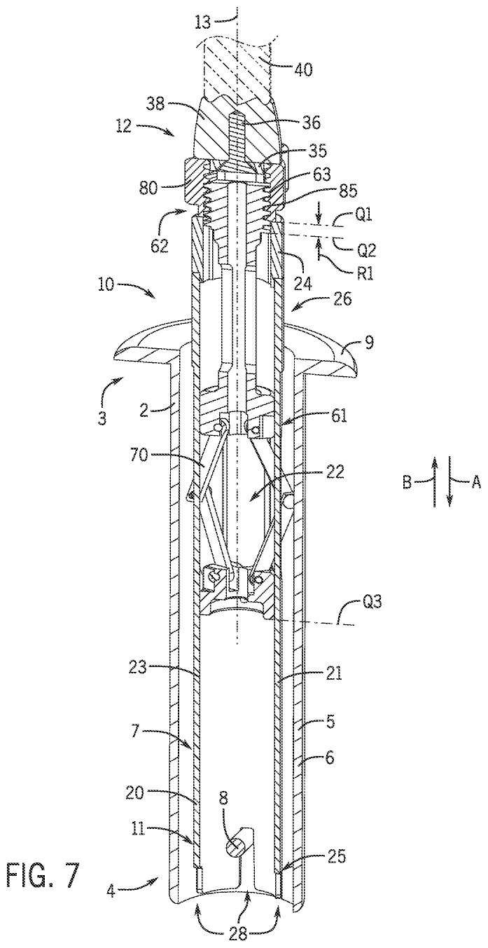

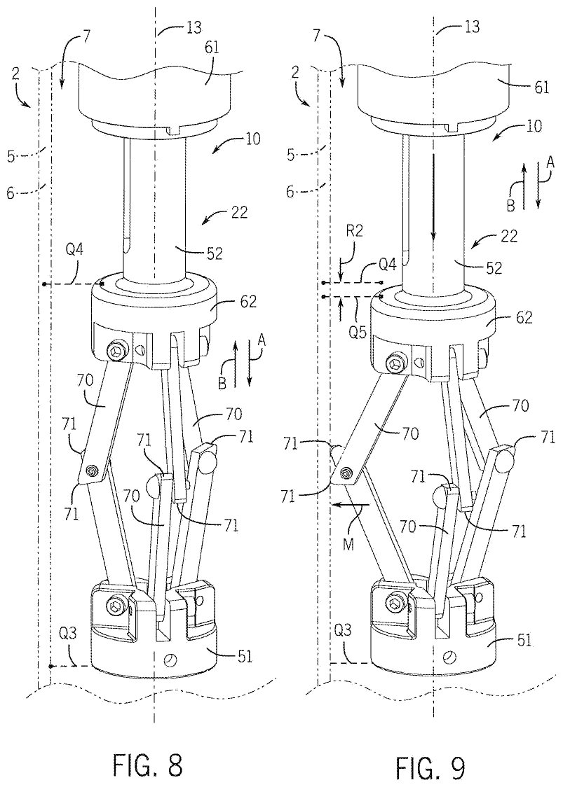

The apparatus 10 also includes a first yoke 51, a second yoke 52, and one or more legs 70 extending between the yokes 51, 52 (see also FIGS. 7-8). These components are positioned in the chamber 22 (see FIG. 4).

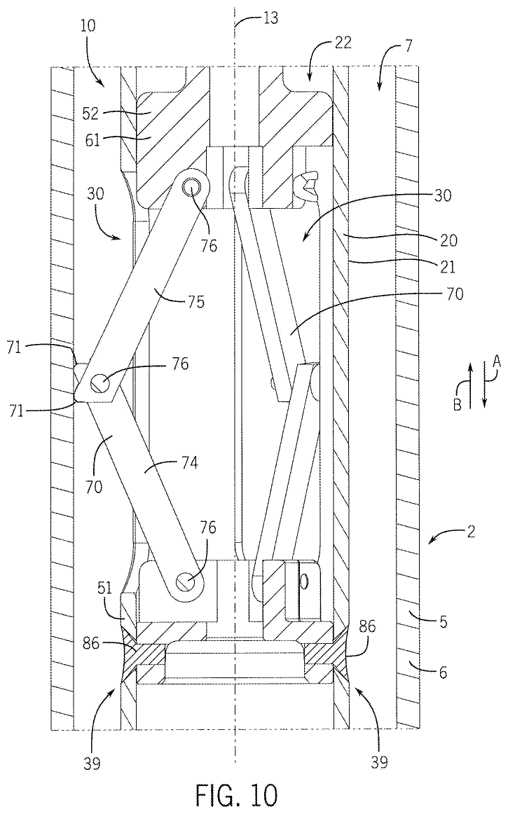

The first yoke 51 is axially fixed relative to the housing sidewall 21. In the depicted example, the first yoke 51 is fixed relieve to the housing sidewall 21 such that the first yoke 51 does not axially move along the axis 13 in either a first axial direction (arrow A) or an opposite second axial direction (arrow B). The first yoke 51 is fixed relative to the housing sidewall 21 in any suitable manner, and in one example, the first yoke 51 is fixed relative to the housing sidewall 21 with one or more screws 86 (FIG. 10), pins, or rivets that extend through holes 39 in the housing 20 to engage the first yoke 51.

The second yoke 52 is spaced apart from the first yoke 51 and coupled to the first yoke 51 with the legs 70. The second yoke 52 has a first end 61 that couples to the legs 70 and an opposite second end 62 with screw threads extending therefrom. The shape of the second yoke 52 and/or the ends 61, 62 may vary. In the example depicted in FIG. 3, the second end 62 is generally rectangular and has two sides from which the screw threads 63 extend. Thus, in this example, the screw threads 63 do not extend continuously around the second end 62. Note that the screw threads 63 extending from the second end 62 extend through the cutouts 32 (see FIG. 4).

As noted above, the legs 70 extend between the yokes 51, 52. The legs 70 are moveable relative to the yokes 51, 52 such that the legs 70 can extend through the openings 30 in the housing sidewall 21 and engage the rod holder sidewall 6 to thereby further secure the apparatus 10 in the rod holder 2 (FIGS. 1-2). Specially, the legs 70 prevent axial movement and/or rotational movement about the axis 13 while the apparatus 10 is in the rod holder 2. The shape, size, and/ component(s) from the legs can vary, and in the example depicted, the legs 70 are bar linkages (e.g., two bar linkage). Each leg 70 in the depicted example has a first bar 74 pivotally coupled to a second bar 75 with a rivet or pin 76. The first bar 74 is also coupled to the first yoke 51, and the second bar 75 is also coupled to the second yoke 52. The bars 74, 75 are coupled to the yokes 51, 52 in any suitable manner, and in the example depicted, ends of the bar 74, 75 are pivotally coupled to the yokes 51, 52 with rivets or pins 76. Each leg 70 has one or more engagement surfaces 71 that contact the rod holder sidewall 6. In the depicted example, an end of each bar 74, 75 has an engagement surface 71 that is curved.

A handle 80 is operable coupled to the second yoke 52. The handle 80 includes an outer surface 81 with one or more lobes 83 extending therefrom. An inner surface 82 defines a channel 84, and screw threads 85 extend from the inner surface 82 into the channel 84. The screw threads 85 engage or mate with the screw threads 63 of the second yoke 52 such that the operation of the handle 80 causes the second yoke 52 to axially move as described below. The handle 80 is positioned between a first section of the second tube 24 and the cap 38, and the handle 80 encircles as second section of the second tube 24. In other examples, the handle 80 is axially slidable along the housing sidewall 21 such that sliding the handle 80 moves the second yoke 52. In these examples, a locking system (e.g., a pawl and rachet system) could be used to prevent inadvertent movement of the handle 80 relative to the housing sidewall 21 once the user moves the handle 80 into a desired position.

FIG. 4 is a cross-sectional view of the apparatus 10 depicted in FIG. 2 with the legs 70 in retracted positions in which the legs 70 do not extend from the housing sidewall 21. Instead, the legs 70 are retracted into and contained within the chamber 22 and/or the openings 30.

An example operation sequence for coupling the apparatus to the rod holder 2 is described hereinbelow.

As noted above, the user first aligns the slots 28 at the first housing end 25 with the gimble bar 8 (see FIG. 2) and then inserts the apparatus 10 into the bore 7 of the rod holder 2 (see FIG. 1). Accordingly, the gimble bar 8 is in the slots 28 and the engagement between the housing sidewall 21 at the first housing end 25 and the gimble bar 8 prevents rotation of the apparatus 10 about the axis 13.

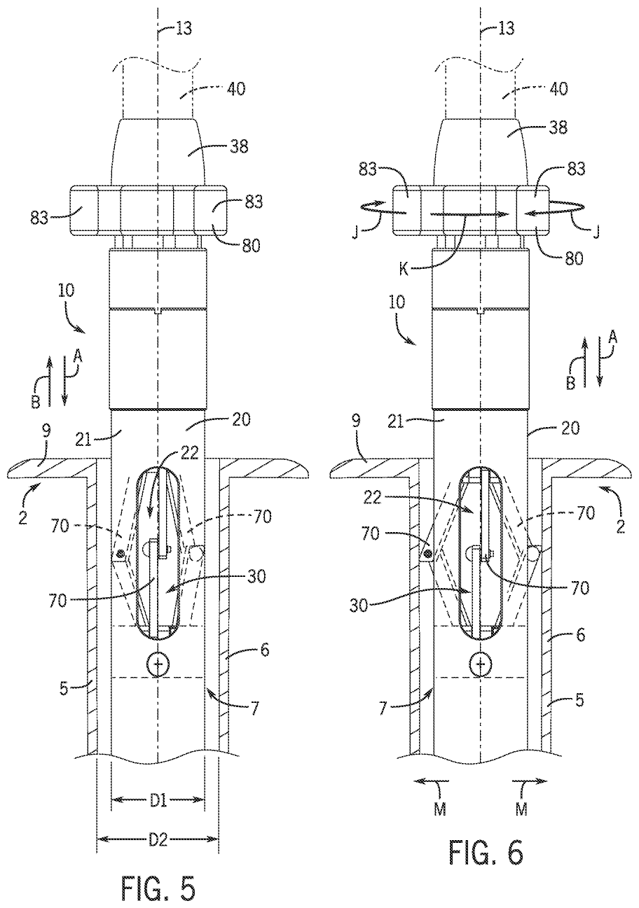

Referring now to FIG. 5, the apparatus 10 is depicted received into the bore 7 of the rod holder 2. The legs 70 are in the retracted positions and thereby do not extend from the housing sidewall 21. Note that in this example the outer diameter D1 of the housing sidewall 21 of the housing 20 is less than the diameter D2 of the bore 7 of the rod holder 2. As such, the apparatus 10 may wobble in the rod holder 2 and/or be moved out of the rod holder 2 in the second axial direction (arrow B) while the legs 70 are in the retracted positions.

As depicted in FIG. 6, to further secure the apparatus 10 in the rod holder 2, the user operates the handle 80 by rotating the handle 80 in a first rotational direction (see arrow J) such that the legs 70 are moved into an extended position. In the extended positions, the legs 70 engage the rod holder sidewall 6 and corresponding friction and/or pressure forces generated by and between the legs 70 and the sidewall of the rod holder 2 prevent the apparatus 10 from being moved in the second axial direction (arrow B) out of the rod holder 2. These friction and/or pressure forces also further prevent rotation of the apparatus 10 about the axis 13. This operation is described in greater detail hereinbelow with reference to FIGS. 7-10.

As noted above, FIG. 5 depicts the legs 70 in the retracted positions. As the user rotates the handle 80 in the first rotational direction (arrow J on FIG. 6), the screw threads 85 of the handle 80 act on the screw threads 63 of the second yoke 52 such that the second yoke 52 is caused to move in the first axial direction (arrow A). As the second yoke 52 begins to move in the first axial direction (arrow A), the first yoke 51 remains axially fixed in the chamber 22 and the legs 70 pivot radially outwardly and extend through the openings 30 in the housing sidewall 21 (see arrows M on FIG. 6). Further axial movement of the second yoke 52 causes further movement of the legs into engagement the rod holder sidewall 6 thereby creating the friction and/or pressure forces between the legs 70 and the rod holder sidewall 6. As such, the apparatus 10 does not axially and/or rotationally move relative to the rod holder 2 when the legs 70 are pivoted radially outwardly and extend through the openings 30 in the housing sidewall 21. The user can continue to rotate the handle 80 in the first rotational direction (arrow J on FIG. 6) to thereby increase engagement and pressure of the legs 70 with the rod holder sidewall 6 to thereby lock the apparatus 10 to the rod holder 2. Note that one example, engagement of the legs 70 with the rod holder sidewall 6 generate forces between the screw threads 63, 85 of the second yoke 52 and the handle 80 which prevent the handle 80 from inadvertently rotating in the opposite second rotational direction (arrow K). In other example, a lock (not depicted) is included to prevent inadvertent rotation of the handle 80.

FIG. 7 depicts axial displacement of the second yoke 52 when the legs 70 are in the extended position (see also FIG. 6) and engaging the rod holder sidewall 6. The axial displacement of the second yoke 52 is depicted as distance R1 which is the distance the bottommost screw thread 63 of the second yoke 52 is moved from a first position Q1 (see also FIG. 4) to a second position Q2 relative to the housing sidewall 21. As noted above, the first yoke 51 remains axially fixed within the chamber 22. FIGS. 4 and 7 each depict the bottom surface of the first yoke 51 fixed at a third position Q3 relative to the housing sidewall 21.

FIGS. 8-9 also depict the axial displacement of the second yoke 52 when the legs are in the extended position (see FIG. 9 and FIG. 6). Specifically, FIG. 8 depicts the legs in the retracted position and an upper surface of the second yoke 52 located at a fourth position Q4 relative to the rod holder sidewall 6. FIG. 9 depicts the legs in the extended position and the upper surface of the second yoke 52 located at a fifth position Q5 relative to the rod holder sidewall 6. Thus, the second yoke 52 axially moved distance R2 as the legs 70 are moved from the retracted position (FIG. 8) to the extended position (FIG. 9). Note that distance R2 may equal distance R1.

To remove the apparatus 10 from the rod holder 2, the user rotates the handle 80 in a second rotational direction (see arrow K on FIG. 6) such that the screw threads 85 of the handle 80 move the second yoke 52 in the second axial direction (arrow B). Accordingly, the legs 70 disengage from the rod holder sidewall 6 and move into the retracted position (see FIG. 5). Thus, the user can remove the apparatus 10 from the rod holder 2.

Referring now to FIG. 10, the legs 70 are depicted in the engaged position and engaging the rod holder sidewall 6. Specifically, the curved engagement surfaces 71 of the leg 70 are contacting the rod holder sidewall 6. The engagement surfaces 71 advantageously do not pierce through the rod holder sidewall 6. Note that in other examples, the legs 70 may be define a sharp edge (not shown) that engages with the rod holder sidewall 6. In these examples, the edge(s) of the legs 70 dig into the rod holder sidewall 6. These example apparatuses may be advantageous for use with rod holders 2 having thick rod holder sidewalls 6.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives and modifications are possible within the scope of the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An apparatus for securing equipment to a rod holder, the apparatus comprising:
a housing extending along a center axis and having a chamber therein, the housing configured to be inserted into the rod holder;
a leg configured to radially extend from the housing to thereby engage the rod holder and prevent movement of the apparatus relative to the rod holder; and
a cap on the housing that is configured to permit the equipment to be coupled to the apparatus.

2. The apparatus according to claim 1, wherein the leg prevents axial movement of the apparatus relative to the rod holder.

3. The apparatus according to claim 1, wherein the leg is moveable into and between: a retracted position in which the leg is within the housing and an extended position in which the leg extends from the housing and engages the rod holder.

4. The apparatus according to claim 3, further comprising a handle operable to move the leg into and between the retracted position and the extended position.

5. The apparatus according to claim 1, further comprising a handle operable to cause the leg to extend from the housing.

6. The apparatus according to claim 5, wherein the handle is rotated in a first rotational direction to thereby cause the leg to extend from the housing and alternatively rotated in a second rotational direction to thereby cause the leg to retract into the housing.

7. The apparatus according to claim 5, further comprising:
a first yoke in the chamber and axially fixed relative to the housing; and
a second yoke in the chamber and spaced apart from the first yoke;
wherein the leg extends between and is coupled to the first yoke and the second yoke; and
wherein as the handle is operated, the second yoke axially moves toward the first yoke thereby causing the leg to extend from the housing.

8. The apparatus according to claim 7, wherein the handle is rotated in a first rotational direction to thereby cause the second yoke to axially move toward the first yoke.

9. The apparatus according to claim 8, wherein the handle is rotated in a second rotational direction opposite the first rotational direction to thereby cause the second yoke to axially move away from the first yoke and the leg to retract into the housing.

10. The apparatus according to claim 7, wherein the handle has screw threads that engage with screw threads of the second yoke such that rotation of the handle causes the screw threads of the handle to act on the screw thread of the second yoke and thereby axially move the second yoke.

11. The apparatus according to claim 1, further comprising:
a first yoke in the chamber and axially fixed relative to the housing; and
a second yoke in the chamber and spaced apart from the first yoke, the second yoke is axially moveable relative to the first yoke;
wherein the leg extends between and is coupled to the first yoke and the second yoke; and
wherein as the second yoke is axially moved toward the first yoke, the leg extends from the housing; and
wherein as the second yoke is axially moved away from the first yoke, the leg retracts into the housing.

12. The apparatus according to claim 11, further comprising a handle rotatable to move the second yoke; and
wherein the handle is rotated in a first rotational direction to thereby cause the second yoke to axially move toward the first yoke.

13. The apparatus according to claim 12, wherein the handle is rotated in a second rotational direction opposite the first rotational direction to thereby cause the second yoke to axially move away from the first yoke and the leg to retract into the housing.

14. The apparatus according to claim 11, wherein the handle has screw threads that engage screw threads of the second yoke such that rotation of the handle causes the screw threads of the handle to act on the screw thread of the second yoke and thereby axially move the second yoke.

15. The apparatus according to claim 1, wherein the leg has a contact surface that engages housing.

16. The apparatus according to claim 1, wherein the leg is a two bar linkage coupled to a first yoke and a second yoke in the chamber.

17. The apparatus according to claim 1, wherein the two bar linkage includes a first bar with a first engagement surface and a second bar with a second engagement surface; and wherein the first engagement surface and the second engagement surface are configured to engage the rod holder.

18. The apparatus according to claim 17, wherein the leg is one of a plurality of legs, and wherein each leg in the plurality of legs are configured to radially extend from the housing to thereby engage the rod holder and prevent movement of the apparatus relative to the rod holder.

19. The apparatus according to claim 1, wherein the legs of the plurality of legs are concentrically spaced around the axis.

20. An apparatus for securing equipment to a rod holder, the apparatus comprising:
a housing extending along a center axis and having a chamber therein, the housing configured to be inserted into the rod holder;
a first yoke is located in the chamber and axially fixed relative to the housing;
a second yoke is located in the chamber and spaced apart from the first yoke;
a leg coupled to and extending between the first yoke and the second yoke;
a cap on the housing and configured to permit the equipment to be coupled to the apparatus; and
a handle operably coupled to the second yoke such that operation of the handle causes the second yoke to axially move toward the first yoke and the leg to radially extend from the housing, wherein the leg is configured to engage the rod holder and prevent movement of the apparatus relative to the rod holder.
